(19) United States
(12) Patent Application Publication
(10) Pub. No.: US 2026/0121087 A1
(43) Pub. Date: Apr. 30, 2026

(54) FUEL CELL STACK

(71) Applicants: Hyundai Motor Company, Seoul (KR); Kia Corporation, Seoul (KR)

(72) Inventor: Jae Bum LIM, Hwaseong-Si (KR)

(73) Assignees: Hyundai Motor Company, Seoul (KR); Kia Corporation, Seoul (KR)

(21) Appl. No.: 19/278,559

(22) Filed: Jul. 23, 2025

(30) Foreign Application Priority Data
Oct. 30, 2024 (KR) 10-2024-0151363

(51) Int. Cl. H01M 8/0276; H01M 8/2475

(52) U.S. Cl. CPC H01M 8/0276; H01M 8/2475

(57) ABSTRACT

A fuel cell stack includes a cell stack including a plurality of unit cells stacked in a first direction, an end plate disposed at at least one of first end portion and second end portion of the cell stack, an enclosure disposed with the end plate to surround a side portion of the cell stack and configured to be divided into a plurality of segments, a first gasket disposed in a first gap defined between the plurality of segments, and a second gasket disposed in a second gap defined between the enclosure and the end plate. The first gasket includes an end portion facing the second gasket in the first direction, and the end portion of the first gasket presses against the second gasket based on the end plate and the enclosure being assembled in the first direction.

The present application claims the benefit of Korean Patent Application No. 10-2024-0151363, filed on Oct. 30, 2024, which is incorporated by reference as if fully set forth herein.

### BACKGROUND OF THE DISCLOSURE

### Field of the Disclosure

Embodiments relate to a fuel cell stack.

### Discussion of the Related Art

A fuel cell is a power generation device which is capable of producing electricity through a chemical reaction of fuel using a catalyst. Such a fuel cell is utilized as a power supply unit in various fields.

Examples of materials used as fuel include hydrogen, hydrocarbons, and hydrocarbon compounds. Among these materials, hydrogen reacts with oxygen to generate water, thermal energy, and electrical energy.

In general, a fuel cell includes a unit cell composed of a membrane electrode assembly (MEA), which includes an oxidation electrode (fuel electrode, hydrogen electrode, or anode) in which hydrogen is oxidized, a reduction electrode (air electrode, oxygen electrode, or cathode) to which oxygen is supplied and in which a reduction reaction occurs, and a polymer electrolyte membrane through which hydrogen ions are transported between the oxidation electrode and the reduction electrode.

The output voltage of a unit cell is only 0.6 V to 1 V. Thus, unit cells are stacked in series to obtain practical output, and a set of stacked cells is called a stack.

Such a fuel cell stack is required to have a high level of airtightness or watertightness for various reasons, such as prevention of electrical energy loss due to leakage of gas in the stack and protection of the fuel cell from external environmental factors.

### SUMMARY

Accordingly, embodiments are directed to a fuel cell stack that substantially obviates one or more problems due to limitations and disadvantages of the related art.

Embodiments provide a fuel cell stack having improved airtightness and watertightness.

However, the aspects of the disclosure are not limited to the above-mentioned aspects, and other aspects not mentioned herein will be clearly understood by those skilled in the art from the following description.

Additional advantages, aspects, and features of the disclosure will be set forth in part in the description which follows and in part will become apparent to those having ordinary skill in the art upon examination of the following or may be learned from practice of the disclosure. The aspects and other advantages of the disclosure may be realized and attained by the structure pointed out in the written description and claims hereof as well as the appended drawings.

A fuel cell stack according to an exemplary embodiment of the present disclosure may include a cell stack including a plurality of unit cells stacked in a first direction, an end plate disposed at at least one of first and second end portions of the cell stack, an enclosure disposed with the end plate to surround a side portion of the cell stack and configured to be divided into a plurality of segments, a first gasket disposed in a first gap defined between the plurality of segments, and a second gasket disposed in a second gap defined between the enclosure and the end plate, wherein the first gasket may include an end portion facing the second gasket in the first direction, and the end portion of the first gasket may press against the second gasket based on the end plate and the enclosure being assembled in the first direction.

In an example, the end plate may include a first end plate disposed at one of the first and second end portions of the cell stack and a second end plate disposed at the remaining one of the two opposite end portions of the cell stack.

In an example, the plurality of segments may include a first segment having an inverted L-shaped appearance and a second segment having an L-shaped appearance.

In an example, the first gap may be defined in a direction parallel to the first direction.

In an example, at least one of the plurality of segments may include a first guide groove formed in a surface thereof defining the first gap, and the first gasket may be guided by and accommodated in the first guide groove. At least one of the enclosure or the end plate may include a second guide groove formed in a surface thereof defining the second gap, and the second gasket may be guided by and accommodated in the second guide groove.

In an example, the first gasket may include a body extending in the first direction and disposed in the first guide groove and at least one protruding portion disposed in a fixing recess adjacent to the first guide groove and protruding from the body in a direction perpendicular to the first direction.

In an example, the first gasket may have higher hardness than the second gasket.

In an example, the end portion of the first gasket may include inclined surfaces converging toward each other in a direction of pressing against the second gasket.

In an example, the first gasket may have a length in the first direction greater than the length of the enclosure in the first direction.

A fuel cell stack according to another embodiment of the present disclosure may include a cell stack including a plurality of unit cells stacked in a first direction, an end plate disposed at at least one of first and second end portions of the cell stack, an enclosure disposed with the end plate to surround a side portion of the cell stack and configured to be divided into a plurality of segments, a first gasket disposed in a first gap defined between the plurality of segments, a second gasket disposed in a second gap defined between the enclosure and the end plate, and a reinforcement member disposed in a third gap defined between the first gasket and the second gasket, wherein the first gasket may press against the reinforcement member based on the enclosure and the end plate being assembled.

In an example, the end plate may include a first end plate disposed at one of the first and second end portions of the cell stack and a second end plate disposed at the remaining one of the two opposite end portions of the cell stack.

In an example, the plurality of segments may include a first segment having an inverted L-shaped appearance and a second segment having an L-shaped appearance.

In an example, the first gap may be defined in a direction parallel to the first direction.

In an example, at least one of the plurality of segments may include a first guide groove formed in a surface thereof defining the first gap, and the first gasket may be guided by and accommodated in the first guide groove. At least one of the enclosure or the end plate may include a second guide groove formed in a surface thereof defining the second gap, and the second gasket may be guided by and accommodated in the second guide groove.

In an example, the first gasket may include a body extending in the first direction and disposed in the first guide groove and at least one protruding portion disposed in a fixing recess adjacent to the first guide groove and protruding from the body in a direction perpendicular to the first direction.

In an example, the first gasket and the second gasket may have hardness values equal to each other or different from each other within a predetermined range.

In an example, the first gasket may have a length in the first direction less than or equal to the length of the enclosure in the first direction.

In an example, the reinforcement member may have a thickness in the first direction greater than a distance between the first gasket and the second gasket.

In an example, the reinforcement member may have lower hardness than the first gasket and the second gasket.

In an example, the reinforcement member may have tensile strength of 0.5 MPa or less.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and form a part of the present application, illustrate embodiment(s) of the disclosure and together with the description are configured to explain the principle of the disclosure. In the drawings:

FIG. 1 is an assembled perspective view of a fuel cell stack according to an exemplary embodiment of the present disclosure;

FIG. 2 is an exploded perspective view of the fuel cell stack according to the exemplary embodiment of the present disclosure;

FIG. 3 is a view showing an enclosure and a first gasket of the fuel cell stack according to the exemplary embodiment of the present disclosure;

FIG. 4A is a view showing a state in which the second segment and the first gasket shown in FIG. 3 are coupled;

FIG. 4B is a view showing a first gasket according to another embodiment;

FIG. 5 is a view of a fuel cell stack according to an exemplary embodiment of the present disclosure with the first segment removed from a portion corresponding to region A shown in FIG. 1;

FIG. 6 is a cross-sectional view of region B shown in FIG. 5;

FIG. 7 is a view of a fuel cell stack according to another embodiment of the present disclosure with the first segment removed from a portion corresponding to region A shown in FIG. 1; and

FIG. 8 is a cross-sectional view of region C shown in FIG. 7.

### DETAILED DESCRIPTION OF THE DISCLOSURE

Hereinafter, embodiments of the present disclosure will be described in detail with reference to the accompanying drawings so that those skilled in the art can easily carry out the embodiments. The present disclosure may, however, be embodied in many different forms, and should not be construed as being limited to the embodiments set forth herein. In the drawings, parts irrelevant to description of the present disclosure will be omitted for clarity. Like reference numerals refer to like elements throughout the specification.

The terminology used herein is for describing embodiments of the present disclosure and is not intended to be limiting of the present disclosure. As used herein, the singular forms “a” and “an” are intended to include the plural forms as well, unless the context clearly indicates otherwise. It will be further understood that the term “include” or “have”, when used herein, specifies the presence of stated features, integers, steps, operations, elements, components, or combinations thereof, but does not preclude the presence or addition of one or more other features, integers, steps, operations, elements, components, or combinations thereof.

The terms “-part”, “-unit”, and “-module” used in the specification mean units for processing at least one function or operation, and may be implemented as hardware, software, or combinations of hardware and software.

Although terms including ordinal numbers, such as “first”, “second”, etc., may be used herein to describe various elements, the elements are not limited by these terms. The terms may be used only as denominative meanings to distinguish one element from another, and sequential meanings thereof are determined not by names, but by context of the corresponding description.

The term “and/or” is used to include any combination of a plurality of items that are the subject matter. For example, “A and/or B” inclusively means all three cases such as “A”, “B”, and “A and B”.

When an element is referred to as being “connected” or “coupled” to another element, the element may be directly connected or coupled to the other element. However, it should be understood that another element may be present therebetween.

Unless otherwise defined, all terms used herein, which include technical or scientific terms, include the same meanings as those generally appreciated by those skilled in the art. The terms, such as ones defined in common dictionaries, should be interpreted as having the same meanings as terms in the context of pertinent technology, and should not be interpreted as having ideal or excessively formal meanings unless clearly defined in the specification.

Hereinafter, a fuel cell stack according to an exemplary embodiment of the present disclosure will be described with reference to the accompanying drawings.

The fuel cell stack will be described using the Cartesian coordinate system (X-axis, Y-axis, Z-axis) for convenience of description, but may also be described using other coordinate systems. In the Cartesian coordinate system, the X-axis, the Y-axis, and the Z-axis are perpendicular to each other, but the exemplary embodiments are not limited thereto. That is, the X-axis, the Y-axis, and the Z-axis may intersect each other obliquely.

Hereinafter, the +X-axis and −X-axis directions are collectively referred to as a first direction, the +Y-axis and −Y-axis directions are collectively referred to as a second direction, and the +Z-axis and −Z-axis directions are collectively referred to as a third direction.

In the embodiments, the first direction may be a stacking direction of the stack. The second direction may be a direction that is laterally perpendicular to the first direction. The third direction may be a direction that is vertically perpendicular to the first direction.

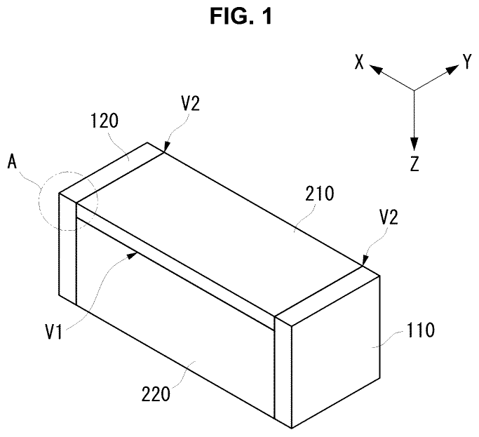

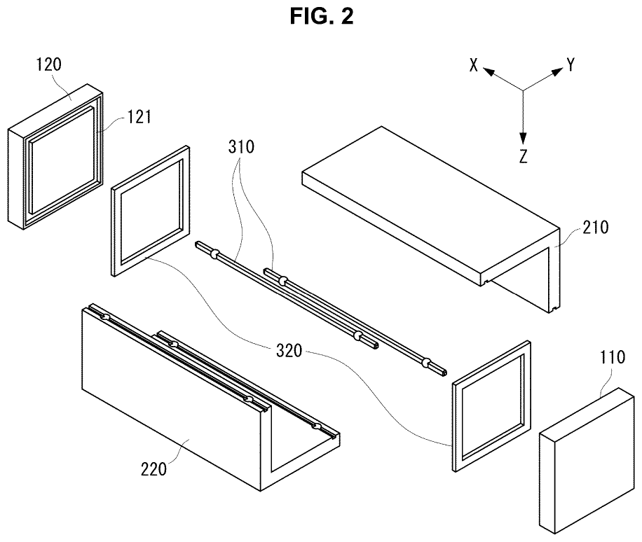

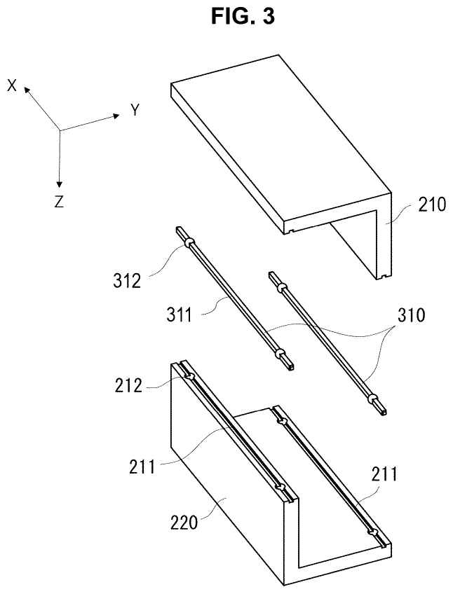

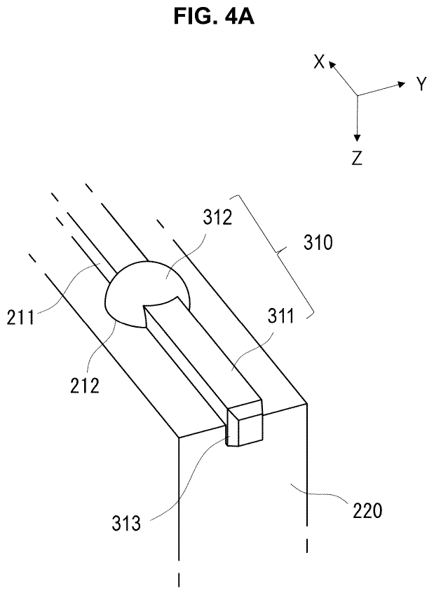

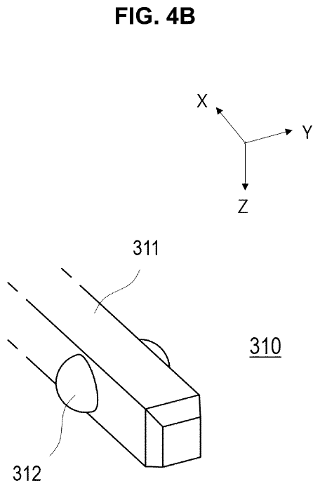

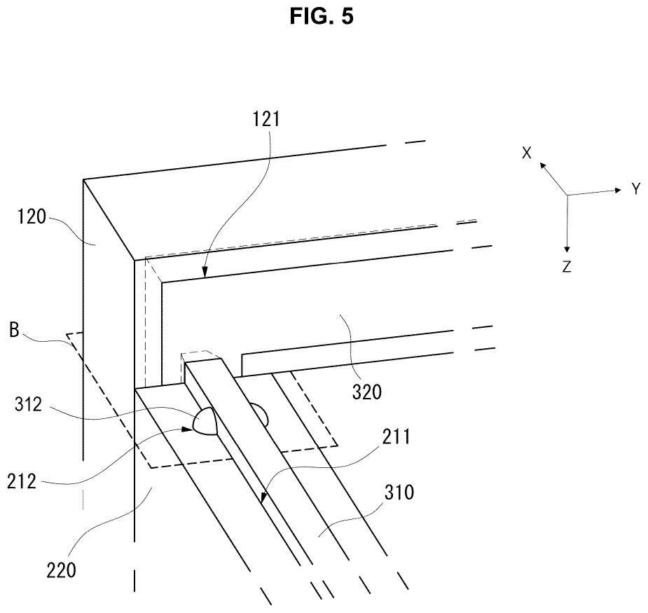

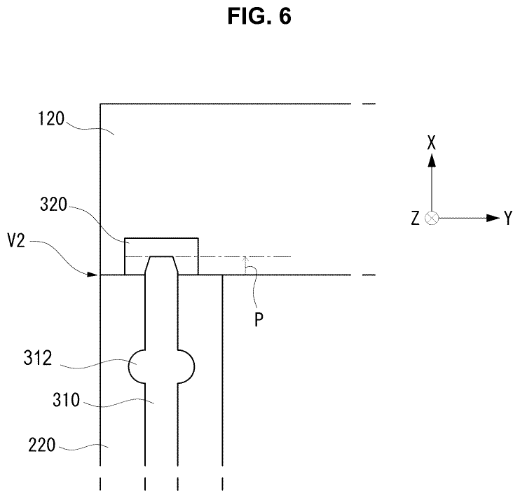

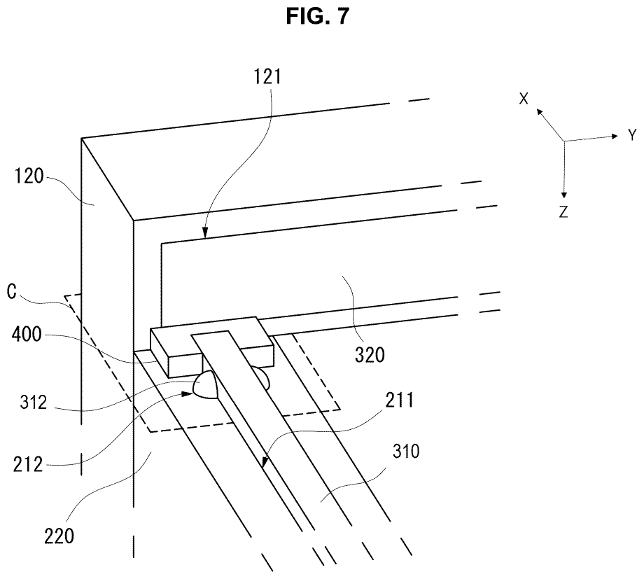

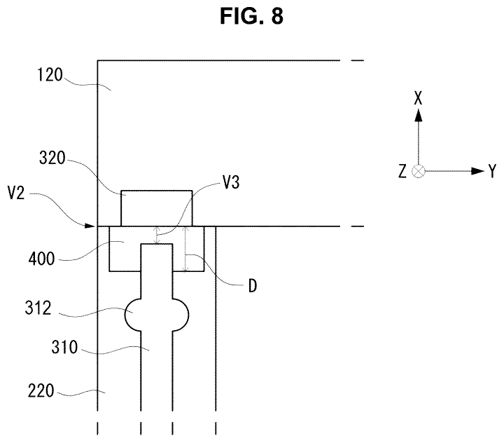

FIG. 1 is an assembled perspective view of a fuel cell stack according to an exemplary embodiment of the present disclosure. FIG. 2 is an exploded perspective view of the fuel cell stack according to the exemplary embodiment of the present disclosure. FIG. 3 is a view showing enclosure 210 and 220 and a first gasket 310 of the fuel cell stack according to the exemplary embodiment of the present disclosure. FIG. 4A is a view showing a state in which the second segment 220 and the first gasket 310 shown in FIG. 3 are coupled and FIG. 4B is a view showing a first gasket 310 according to another embodiment. FIG. 5 is a view of a fuel cell stack according to an exemplary embodiment of the present disclosure with the first segment 210 removed from a portion corresponding to region A shown in FIG. 1. FIG. 6 is a cross-sectional view of region B shown in FIG. 5. FIG. 7 is a view of a fuel cell stack according to another embodiment of the present disclosure with the first segment 210 removed from a portion corresponding to region A shown in FIG. 1. FIG. 8 is a cross-sectional view of region C shown in FIG. 7.

For convenience of description, illustration of unit cells is omitted in FIGS. 1 to 8.

Referring to FIGS. 1 and 2, the fuel cell stack according to the exemplary embodiment of the present disclosure includes a cell stack in which a plurality of unit cells is stacked in the first direction (X-axis direction), end plates 110 and 120 disposed at respective end portions of the cell stack, and enclosure 210 and 220 disposed with the end plates 110 and 120 to surround a side portion of the cell stack and protect the cell stack.

The end plates 110 and 120 may include a first end plate 110 disposed at one of the two opposite end portions of the cell stack and a second end plate 120 disposed at the other of the two opposite end portions of the cell stack.

The enclosure 210 and 220 may be divided into two or more segments. In the drawings, the enclosure 210 and 220 is illustrated as being divided into a first segment 210 having an inverted L-shaped appearance and a second segment 220 having an L-shaped appearance. These shapes of the segments are merely examples, and the exemplary embodiments are not limited thereto. For example, the segments may respectively have a U-shape rotated by 90 degrees and an I-shape, which are complementary to each other. Alternatively, the segments may be complementary U-shapes rotated by 90 degrees, in each of which the upper and lower sides differ in length. In other embodiments, the enclosure may be divided into three or four segments.

When the enclosure is divided into a plurality of segments, a start point of the division surface may be at the first end plate 110, and an end point thereof may be at the second end plate 120. That is, a first gap V1 may be defined in a direction parallel to the first direction.

When the plurality of segments 210 and 220 forming the enclosure is coupled to each other a region between coupling surfaces of the segments 210 and 220 may not be completely sealed, and thus the first gap V1 may be disposed between the coupling surfaces. To ensure airtightness of the fuel cell stack, a first gasket 310 may be disposed in the first gap V1.

To ensure stable seating of the first gasket 310, at least one of the plurality of segments 210 and 220 may include a first guide groove 211 formed in the coupling surface defining the first gap V1 to guide the first gasket 310.

The first guide groove 211 may be formed in the coupling surface of the first segment 210, the coupling surface of the second segment 220, or both the coupling surfaces, which together define the first gap V1. For example, the first guide groove 211 may be formed in the coupling surface of the first segment 210. In the exemplary embodiment, the coupling surface of the second segment 220 that faces the coupling surface of the first segment 210 may be flat. Alternatively, the first guide groove 211 may be formed in the coupling surface of the second segment 220. In the exemplary embodiment, the coupling surface of the first segment 210 that faces the coupling surface of the second segment 220 may be flat. Alternatively, each of the first segment 210 and the second segment 220 may include the first guide groove 211 to accommodate the first gasket 310 when the first and second segments 210 and 220 are coupled to each other. In the drawings, the first guide groove 211 is illustrated as being formed in both the first segment 210 and the second segment 220.

As the first segment 210 and the second segment 220 are coupled, the first gasket 310 may be compressed within the first guide groove 211, ensuring airtightness and watertightness between the first segment 210 and the second segment 220.

The enclosure formed by the coupling of the plurality of segments 210 and 220 may be disposed with the first end plate 110 and the second end plate 120 in the first direction.

Similar to the plurality of segments 210 and 220, a second gap V2 may be disposed between a coupling surface of each end plate and a coupling surface of the enclosure. To ensure airtightness at the second gap V2, a second gasket 320 may be disposed in the second gap V2.

To ensure stable seating of the second gasket 320, at least one of the end plate 110 or 120 or the enclosure 210 and 220 may include a second guide groove 121 formed in the coupling surface defining the second gap V2 to guide the second gasket 320.

The second guide groove 121 may be formed in the coupling surface of the end plate 110 or 120, the coupling surface of the enclosure 210 and 220, or both the coupling surfaces, which together define the second gap V2. For example, the second guide groove 121 may be formed in the coupling surface of the end plate 110 or 120. In the exemplary embodiment, the coupling surface of the enclosure 210 and 220 that faces the coupling surface of the end plate 110 or 120 may be flat. Alternatively, the second guide groove 121 may be formed in the coupling surface of the enclosure 210 and 220. In the exemplary embodiment, the coupling surface of the end plate 110 or 120 that faces the coupling surface of the enclosure 210 and 220 may be flat. Alternatively, each of the enclosure 210 and 220 and the end plate 110 or 120 may include the second guide groove 121 to accommodate the second gasket 320 when the enclosure 210 and 220 and the end plate 110 or 120 are disposed with each other. In the drawings, the second guide groove 121 is illustrated as being formed only in the coupling surface of each of the end plates 110 and 120.

FIG. 3 is an exploded perspective view of the enclosure 210 and 220 including the first segment 210 and the second segment 220 and the first gasket 310. FIG. 4A is a view showing a state in which the first gasket 310 is coupled to the second segment 220, and FIG. 4B is a view showing a protruding portion 312 according to another embodiment.

Referring to FIGS. 3 to 4A, the first gasket 310 may include a body 311 extending in the first direction and disposed in the first guide groove and at least one protruding portion 312 disposed in a fixing recess 212 adjacent to the first guide groove and protruding from the body 311 in a direction perpendicular to the first direction.

The protruding portion 312 may fix the body 311 of the first gasket 310 so that the body 311 does not move in the first direction within the first guide groove 211. In the drawings, the protruding portion 312 is illustrated in a spherical shape. However, this is merely an example, and the protruding portion 312 may have any other shape, when the same protrudes in a direction perpendicular to the first direction. For example, the protruding portion 312 may be formed in a hemispherical shape protruding from a side surface of the first gasket 310, as shown in FIG. 4B.

The first guide groove may include a fixing recess 212 including a shape corresponding to the protruding portion 312 of the first gasket 310. The protruding portion 312 of the first gasket 310 may be accommodated in the fixing recess 212 of the first guide groove, fixing the first gasket 310 to prevent movement of the first gasket 310 in the first direction.

The first gasket 310 may ensure airtightness and watertightness at the first gap V1 between the plurality of segments 210 and 220 forming the enclosure, and the second gasket 320 may ensure airtightness and watertightness at the second gap V2 between the enclosure 210 and 220 and each of the end plates 110 and 120.

A third gap V3 may be defined at the interface between the first gasket 310 and the second gasket 320. This third gap V3 may degrade the airtightness and watertightness performance of the fuel cell stack. Therefore, the present disclosure proposes embodiments to seal the third gap V3. The foregoing description pertains to features common to various exemplary embodiments to be described below.

Hereinafter, a fuel cell stack according to one embodiment will be described with reference to FIGS. 5 and 6. FIG. 5 is a view showing a fuel cell stack according to one embodiment of the present disclosure with the first segment 210 removed from a portion corresponding to region A shown in FIG. 1. FIG. 6 is a cross-sectional view of region B shown in FIG. 5.

The fuel cell stack according to the exemplary embodiment includes a first gasket 310 and a second gasket 320 having different physical properties. The physical properties may include hardness, strength (tensile strength), and stiffness. When the enclosure 210 and 220 and the end plates 110 and 120 are assembled, the gasket having higher physical properties may press against the gasket having lower physical properties. Accordingly, it may be possible to prevent a gap from being formed between the first gasket 310 and the second gasket 320.

FIGS. 5 and 6 show an example in which an end portion of the first gasket 310 presses against the second gasket 320. To achieve the present example, the first gasket 310 may have higher hardness than the second gasket 320, and the length of the first gasket 310 in the first direction may be greater than that of the enclosure 210 and 220 in the first direction.

As a result of testing for airtightness and watertightness, when the first gasket 310 was made of ethylene propylene diene M-class rubber (EPDM) and the second gasket 320 was made of a silicone foam pad, airtightness and watertightness performance corresponding to the IPX7 grade, as defined by the International Electrotechnical Commission (IEC) under the IEC 529 standard for waterproofing, was achieved. However, when both the first gasket 310 and the second gasket 320 were made of EPDM, the airtightness and watertightness performance did not satisfy the IPX7 grade.

According to the above test results, it may be understood that the greater the difference in mechanical strength (compressive strength/hardness) between the first gasket 310 and the second gasket 320, and the greater the elongation of the second gasket 320, the more the interface between the first gasket 310 and the second gasket 320 is reduced.

Furthermore, it may be advantageous that the first gasket 310 be made of a soft rubber material (e.g., ethylene propylene diene M-class rubber (EPDM)) having Shore hardness of 50 to 70 and tensile strength of 5 MPa or greater and that the second gasket 320 be made of a silicone foam pad having tensile strength of 0.5 MPa or less. However, the exemplary embodiments are not limited thereto.

Furthermore, it may be advantageous that materials having higher physical properties be used for the first gasket 310 and the second gasket 320 as higher watertight and airtight pressures are required.

Referring to FIG. 6, to allow the first gasket 310 to press against the second gasket 320, the length of the first gasket 310 in the X-axis direction may be greater than that of the second segment 220 in the X-axis direction (P>0). Alternatively, in the state in which the second end plate 120 and the second segment 220 are assembled, an end surface of the first gasket 310 in the +X-axis direction may be positioned farther in the +X-axis direction than an end surface of a portion of the second gasket 320, against which the first gasket 310 does not press, in the −X-axis direction.

The protruding portion 312 of the first gasket 310 may be accommodated in the fixing recess 212 within the first guide groove 211, fixing the degree to which the first gasket 310 protrudes (protruding amount) and supporting the first gasket 310 so that an end portion of the first gasket 310 presses against the second gasket 320.

In addition, the end portion of the first gasket 310 may be a pointed or slanted shape to easily press against the second gasket 320. The side surfaces 313 of the end portion of the first gasket 310, which face in the Y-axis and Z-axis directions, may be inclined to converge toward each other.

Due to the structure in which the first gasket 310 presses against the second gasket 320 due to the difference in physical properties, an open loop at the interface between two or more gaskets may be reinforced into a closed loop. Unlike conventional liquid sealing materials such as sealants, the present structure does not cause damage during disassembly, and does not require a separate curing time or filling condition, providing advantages in terms of work efficiency and material cost. In addition, airtightness and watertightness of a consistent level may always be secured regardless of work conditions such as temperature or the skill of the operator. Furthermore, as the relatively hard gasket presses against the relatively soft gasket, the interface between the gaskets or the interface having an uneven surface roughness between surrounding components may be tightly sealed, improving airtightness and watertightness between the components.

Hereinafter, a fuel cell stack according to another embodiment will be described with reference to FIGS. 7 and 8. FIG. 7 is a view showing a fuel cell stack according to another embodiment of the present disclosure with the first segment 210 removed from a portion corresponding to region A shown in FIG. 1. FIG. 8 is a cross-sectional view of region C shown in FIG. 7.

Unlike the previous embodiment, the fuel cell stack according to the other embodiment may include a first gasket 310 and a second gasket 320 having similar physical properties (e.g., hardness and strength), and may further include a reinforcement member 400 disposed between the first gasket 310 and the second gasket 320.

The length of the first gasket 310 in the first direction may be less than or equal to the length of the enclosure 210 and 220 in the first direction. The first gasket 310, which is shorter than the enclosure 210 and 220, may define a third gap V3 between the first gasket 310 and the second gasket 320. The reinforcement member 400 may be disposed in the third gap V3.

The reinforcement member 400 may have a thickness sufficient to fill the empty space (i.e., the third gap V3) between the first gasket 310 and the second gasket 320 during assembly. Thus, the thickness D of the reinforcement member 400 in the first direction may be greater than a distance between the first gasket 310 and the second gasket 320, that is, the length of the third gap V3 in the first direction. Accordingly, as the second end plate 120 and the enclosure 210 and 220 (e.g., the second segment 220) are assembled, the reinforcement member 400 may be compressed by the first gasket 310 and the second gasket 320, ensuring airtightness and watertightness at the third gap V3.

As a result of testing for airtightness and watertightness, when the first gasket 310 and the second gasket 320 were made of ethylene propylene diene M-class rubber (EPDM) and the reinforcement member 400 was made of a silicone foam pad, airtightness and watertightness performance corresponding to the IPX7 grade mentioned above was achieved.

In addition, it may be advantageous that the reinforcement member 400 be made of a silicone foam pad having tensile strength (e.g., hardness or stiffness) of 0.5 MPa or less. However, this is merely an example, and the exemplary embodiments are not limited thereto. The reinforcement member 400 may be made of any other material, so long as the same has lower tensile strength than the first gasket 310 and the second gasket 320.

Furthermore, the first gasket 310 and the second gasket 320 may be made of a soft rubber material having Shore hardness of 50 to 70 and tensile strength of 5 MPa or greater, such as ethylene propylene diene M-class rubber (EPDM), and may be made of the same material. However, this is merely an example, and the exemplary embodiments are not limited thereto.

Due to the structure in which the interface between the first gasket 310 and the second gasket 320 is filled as the reinforcement member 400 made of a soft material is compressed, an open loop at the interface between two or more gaskets may be reinforced into a closed loop. Unlike conventional liquid sealing materials such as sealants, the present structure does not cause damage during disassembly, and does not require a separate curing time or filling condition, providing advantages in terms of work efficiency and material cost. Furthermore, airtightness and watertightness of a consistent level may always be secured regardless of work conditions such as temperature or the skill of the operator. Furthermore, the reinforcement member 400 including a soft material may fill the interface between the gaskets or the interface having an uneven surface roughness between surrounding components, improving airtightness and watertightness between the components.

As described above, the present disclosure proposes embodiments of the fuel cell stack having improved airtightness and watertightness using different types of gaskets having different physical properties or the physical reinforcement member 400.

According to the exemplary embodiments of the present disclosure, a quantitative effect may be obtained by greatly reducing performance variation, and work convenience may be improved, compared to the conventional stack using liquid sealing materials that require a high level of operator's skill. Furthermore, since structural damage does not occur during disassembly, work efficiency may be improved, and material cost may not be wasted.

As is apparent from the above description, the fuel cell stack according to the exemplary embodiments of the present disclosure may improve watertightness and airtightness performance by sealing or filling an interface between an enclosure and an end plate or between gaskets.

Furthermore, the fuel cell stack according to the exemplary embodiments of the present disclosure may improve work efficiency and may quantitatively secure watertightness and airtightness performance, compared to the conventional stack using liquid sealing materials that exhibit performance variation depending on work conditions such as temperature or the skill of the operator and cause damage to the stack structure during disassembly. Furthermore, because structural damage does not occur during disassembly, waste of material cost may be prevented.

However, the effects achievable through the disclosure are not limited to the above-mentioned effects, and other effects not mentioned herein will be clearly understood by those skilled in the art from the above description.

Although only a limited number of embodiments have been described above, various other embodiments are possible. The technical contents of the above-described embodiments may be combined into various forms as long as they are not incompatible with one another, and thus may be implemented in new embodiments.

It will be apparent to those skilled in the art that various changes in form and details may be made without departing from the spirit and essential characteristics of the disclosure set forth herein. Accordingly, the above detailed description is not intended to be construed to limit the disclosure in all aspects and to be considered by way of example. The scope of the disclosure should be determined by reasonable interpretation of the appended claims and all equivalent modifications made without departing from the disclosure should be included in the following claims.

What is claimed is:

1. A fuel cell stack, comprising:
a cell stack including a plurality of unit cells stacked in a first direction;
an end plate disposed at at least one of first end portion and second end portion of the cell stack;
an enclosure including a plurality of segments and disposed to surround a side portion of the cell stack;
a first gasket disposed in a first gap defined between the plurality of segments; and
a second gasket disposed in a second gap defined between the enclosure and the end plate,
wherein the first gasket includes an end portion facing the second gasket in the first direction, and the end portion of the first gasket presses against the second gasket based on the end plate and the enclosure being assembled in the first direction.

2. The fuel cell stack of claim 1, wherein the end plate includes:
a first end plate disposed at one of the first end portion and second end portion of the cell stack; and
a second end plate disposed at a remaining one of the first end portion and second end portion of the cell stack.

3. The fuel cell stack of claim 1, wherein the plurality of segments includes:
a first segment having an inverted L-shaped appearance; and
a second segment having an L-shaped appearance.

4. The fuel cell stack of claim 1, wherein the first gap is defined in a direction parallel to the first direction.

5. The fuel cell stack of claim 1,
wherein at least one of the plurality of segments includes a first guide groove formed in a surface thereof defining the first gap,
wherein the first gasket is disposed in the first guide groove,
wherein at least one of the enclosure or the end plate includes a second guide groove formed in a surface thereof defining the second gap, and
wherein the second gasket is disposed in the second guide groove.

6. The fuel cell stack of claim 5, wherein the first gasket includes:
a body extending in the first direction and disposed in the first guide groove including a fixing recess; and
at least one protruding portion disposed in the fixing recess, which is adjacent to the first guide groove, and protruding from the body in a direction perpendicular to the first direction.

7. The fuel cell stack of claim 1, wherein the first gasket has higher hardness than the second gasket.

8. The fuel cell stack of claim 1, wherein the end portion of the first gasket includes inclined surfaces converging toward each other in a direction of pressing against the second gasket.

9. The fuel cell stack of claim 1, wherein the first gasket has a length in the first direction greater than a length of the enclosure in the first direction.

10. A fuel cell stack, comprising:
a cell stack including a plurality of unit cells stacked in a first direction;
an end plate disposed at at least one of first end portion and second end portion of the cell stack;
an enclosure including a plurality of segments and disposed to surround a side portion of the cell stack;
a first gasket disposed in a first gap defined between the plurality of segments;
a second gasket disposed in a second gap defined between the enclosure and the end plate; and
a reinforcement member disposed in a third gap defined between the first gasket and the second gasket,
wherein the first gasket presses against the reinforcement member based on the enclosure and the end plate being assembled.

11. The fuel cell stack of claim 10, wherein the end plate includes:
a first end plate disposed at one of the first end portion and second end portion of the cell stack; and
a second end plate disposed at a remaining one of the first end portion and second end portion of the cell stack.

12. The fuel cell stack of claim 10, wherein the plurality of segments includes:
a first segment having an inverted L-shaped appearance; and
a second segment having an L-shaped appearance.

13. The fuel cell stack of claim 10, wherein the first gap is defined in a direction parallel to the first direction.

14. The fuel cell stack of claim 10,
wherein at least one of the plurality of segments includes a first guide groove formed in a surface thereof defining the first gap,
wherein the first gasket is disposed in the first guide groove,
wherein at least one of the enclosure or the end plate includes a second guide groove formed in a surface thereof defining the second gap, and
wherein the second gasket is disposed in the second guide groove.

15. The fuel cell stack of claim 14, wherein the first gasket includes:
a body extending in the first direction and disposed in the first guide groove including a fixing recess; and
at least one protruding portion disposed in the fixing recess adjacent to the first guide groove and protruding from the body in a direction perpendicular to the first direction.

16. The fuel cell stack of claim 10, wherein the first gasket and the second gasket have hardness values equal to each other or different from each other within a predetermined range.

17. The fuel cell stack of claim 10, wherein the first gasket includes a length in the first direction less than or equal to a length of the enclosure in the first direction.

18. The fuel cell stack of claim 10, wherein the reinforcement member has a thickness in the first direction greater than a distance between the first gasket and the second gasket.

19. The fuel cell stack of claim 10, wherein the reinforcement member has lower hardness than the first gasket and the second gasket.

20. The fuel cell stack of claim 10, wherein the reinforcement member has tensile strength of 0.5 MPa or less.
